(19) United States
(12) Patent Application Publication
(10) Pub. No.: US 2015/0094985 A1
(43) Pub. Date: Apr. 2, 2015

(54) GRAPHICAL IDENTIFICATION OF MISBEHAVING SYSTEMS

(71) Applicant: International Business Machines Corporation, Armonk, NY (US)

(72) Inventors: Robert Birke, Kilchberg (CH); Yiyu L. Chen, Rueschlikon (CH)

(73) Assignee: International Business Machines Corporation, Armonk, NY (US)

(21) Appl. No.: 14/041,610

(22) Filed: Sep. 30, 2013

(51) Int. Cl. G06F 9/455

(52) U.S. Cl. CPC G06F 9/45545
USPC 702/183

(57) ABSTRACT

In an exemplary embodiment, a computer-implemented method includes receiving a plurality of load data related to a plurality of physical machines in a computing environment. The plurality of load data is converted to a plurality of data points, each data point representing a corresponding physical machine from among the physical machines. A graph is generated, by a computer processor, of the plurality of data points representing the plurality of physical machines. A misbehavior alert is output for each of the physical machines that falls outside a predetermined safe range in the graph.

### BACKGROUND

Various embodiments of this disclosure relate to cloud computing and, more particularly, to identifying physical machines that are performing outside expectations within a computing environment.

When running a data center or cloud computing environment, which includes multiple physical machines, it is beneficial to react efficiently to problems in the various machines. These problems can be, for example, complete system failures or just performance problems. Traditionally, performance problems can be more difficult to identify than system failures.

### SUMMARY

In one embodiment of this disclosure, a computer-implemented method includes receiving a plurality of load data related to a plurality of physical machines in a computing environment. The plurality of load data is converted to a plurality of data points, each data point representing a corresponding physical machine from among the physical machines. A graph is generated, by a computer processor, of the plurality of data points representing the plurality of physical machines. A misbehavior alert is output for each of the physical machines that falls outside a predetermined safe range in the graph.

In another embodiment, a system includes a load converter, a plotter, and a ticketer. The load converter is configured to receive a plurality of load data related to a plurality of physical machines in a computing environment, and to convert the plurality of load data to a plurality of data points, each data point representing a corresponding physical machine from among the physical machines. The plotter is configured to generate, by a computer processor, a graph of the plurality of data points representing the plurality of physical machines. The ticketer is configured to output a misbehavior alert for each of the physical machines that falls outside a predetermined safe range in the graph.

In yet another embodiment, a computer program product includes a computer readable storage medium having computer readable program code embodied thereon. The computer readable program code is executable by a processor to perform a method. The method includes receiving a plurality of load data related to a plurality of physical machines in a computing environment. Further according to the method, the plurality of load data is converted to a plurality of data points, each data point representing a corresponding physical machine from among the physical machines. A graph is generated of the plurality of data points representing the plurality of physical machines. A misbehavior alert is output for each of the physical machines that falls outside a predetermined safe range in the graph.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of a computer system for use in implementing a detection system or method, according to some embodiments of this disclosure;

FIG. 2 is a block diagram of the detection system, according to some embodiments of this disclosure;

FIG. 3 is a scatter plot illustrating aggregate virtual load versus physical load for physical machines in a computing environment, according to some embodiments of this disclosure;

FIG. 4 is a second scatter plot illustrating aggregate virtual load versus physical load for physical machines in a computing environment, according to some embodiments of this disclosure; and

FIG. 5 is a flow diagram of a method for detecting a misbehaving physical machine in a computing environment.

### DETAILED DESCRIPTION

Various embodiments of this disclosure are detection systems and methods, configured to detect not only system failures in a computing environment, but also performance issues of the various systems in the environment.

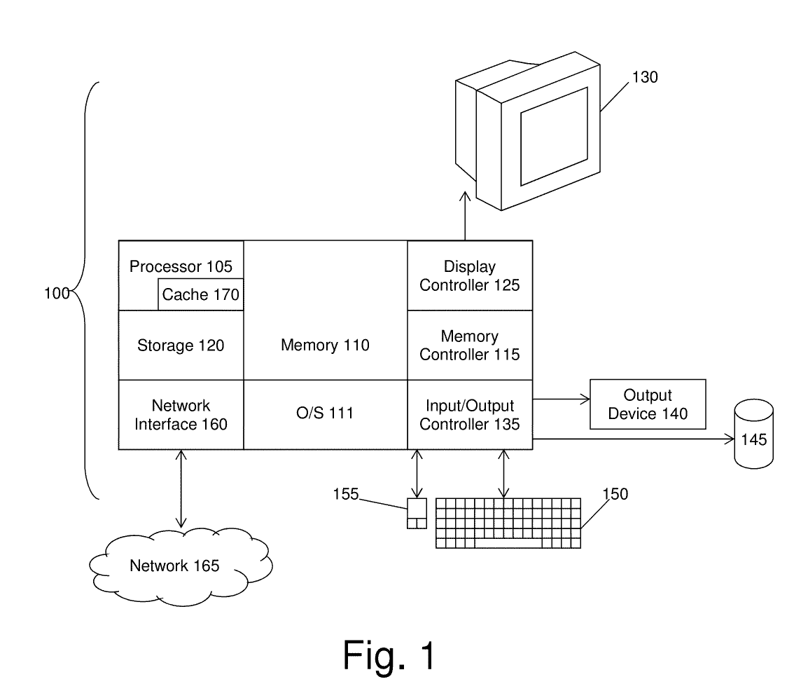

FIG. 1 illustrates a block diagram of a computer system 100 for use in implementing a detection system or method according to some embodiments. The detection systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a personal computer, workstation, minicomputer, or mainframe computer.

In an exemplary embodiment, as shown in FIG. 1, the computer system 100 includes a processor 105, memory 110 coupled to a memory controller 115, and one or more input and/or output (I/O) devices 140 and 145, such as peripherals, that are communicatively coupled via a local I/O controller 135. The I/O controller 135 may be, for example but not limitation, one or more buses or other wired or wireless connections, as are known in the art. The I/O controller 135 may have additional elements, which are omitted for simplicity, such as controllers, buffers (caches), drivers, repeaters, and receivers, to enable communications.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive.

In an exemplary embodiment, a conventional keyboard 150 and mouse 155 may be coupled to the I/O controller 135. Other output devices such as the I/O devices 140 and 145 may include input devices, for example but not limited to, a printer, a scanner, a microphone, and the like. The I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Detection systems and methods according to this disclosure may be embodied, in whole or in part, in computer program products or in computer systems 100, such as that illustrated in FIG. 1.

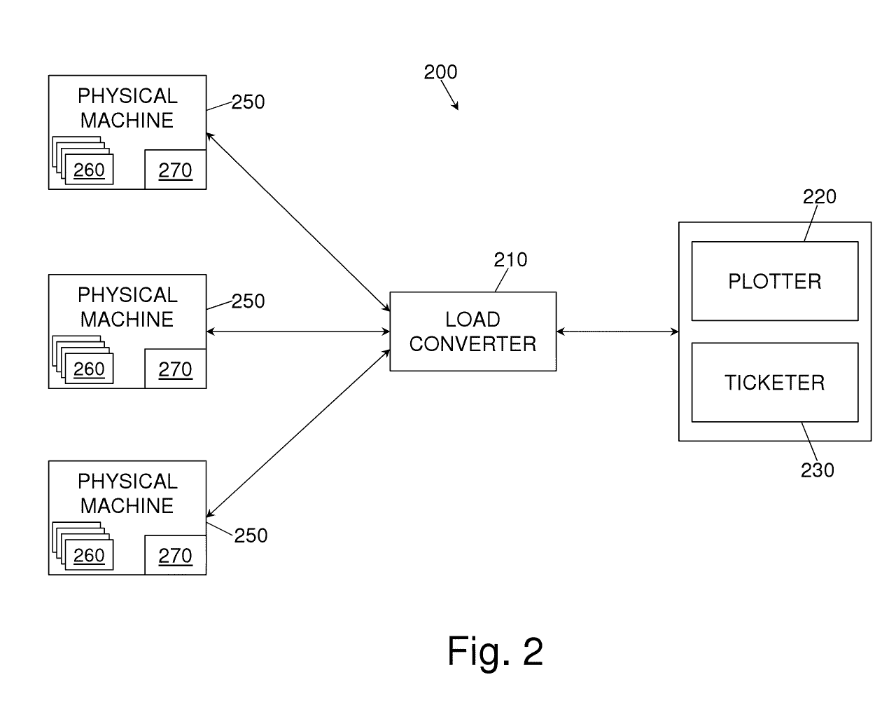

FIG. 2 is a block diagram of a detection system 200 according to some exemplary embodiments of this disclosure. The detection system 200 may be configured to detect and report physical machines 250 that are deemed to be misbehaving. As shown, the detection system 200 may include a load converter 210, a plotter 220, and a ticketer 230, one or more of which may be in communication with one or more physical machines 250. The load converter 210, the plotter 220, and the ticketer 230 may each include hardware, software, or a combination of both, and may be embodied in whole or in part in a computer system 100. Although the load converter 210, the plotter 220, and the ticketer 230 are shown in FIG. 2 as being distinct, these aspects may share hardware, software, or both, dependent on implementation.

Each physical machine 250 may be a hardware computing device, such as computer system 100, configured to run one or more virtual machines 260 as well as an agent 270. On a physical machine 250, an associated agent 270 may run and monitor information about that physical machine 250. That information may be provided by the agent 270 to the load converter 210 in the form of load data related to, or describing, the physical machine 250. The load data for a physical machine 250 may include, for example, the number of virtual machines 260 running on that physical machine 250, the CPU utilization of those virtual machines 260, the memory utilization of those virtual machines 260, the number of virtual processors allotted to each of the virtual machines 260, the CPU utilization of the physical machine 250, the memory utilization of the physical machine 250, and the number of physical CPUs of the physical machine 250. By receiving load data from multiple agents 270, each associated with a physical machine 250, the load converter 210 may have access to load data related to the multiple physical machines 250 in the environment of the detection system 200.

The load converter 210 may convert the load data for the various physical machines 250 into converted data having at least two dimensions. For example, after conversion of load data for a first physical machine 250, the converted data may be a data point that includes a virtual load representation and a physical load representation, each of which forms a dimension of the converted data. In some embodiments, for each physical machine 250, the load converter 210 may therefore apply a conversion formula to the associated load data. The conversion formula may input the load data and output a virtual load and a physical load of the associated physical machine 250. After the load data for the various physical machines 250 has been converted, or mapped, to converted data, the resulting converted data may be plotted in two or more dimensions. The detection system 200 may analyze the resulting plot to identify misbehaving physical machines 250.

The conversion formula used by the load converter 210 to map the load data to a set of data points, i.e., the converted data, may vary based on implementation. In an exemplary embodiment, for example, the conversion formula for converting a physical machine's load data into a representation of aggregate virtual load is as follows:

$${\sum }_{i = 1}^{N} {I}_{i} {V}_{i}$$

In the above formula, the following representations are made: N represents the quantity of virtual machines 260 running on the physical machine in 250 in question, where the virtual machines 260 are numbered 1 through N; Vᵢ represents the number of virtual CPUs assigned to the i^{th} virtual machine 260; I represents the CPU load of the i^{th} virtual machine 260. Thus, the above formula represents the aggregate virtual load of the physical machine 250 as the sum of the load on each virtual machine 260 running on the physical machine 250.

The physical load of a physical machine may be calculated as L*P, where P represents the quantity of physical CPUs, and L represents the total CPU load of the physical machine 250.

It may generally be beneficial or expected for the processing power of a physical machine 250 to be allotted to its virtual machines 260 according to the number of virtual CPUs assigned to each virtual machine 260. Thus, if the resources of a physical machine 250 are allocated properly, the physical load as defined above may be approximately equal to the aggregate virtual load as defined above. However, to allow for some degree of variation from this equality, a range may be allowed such that the aggregate virtual load of a physical machine 250 need not be exactly equal to the physical load.

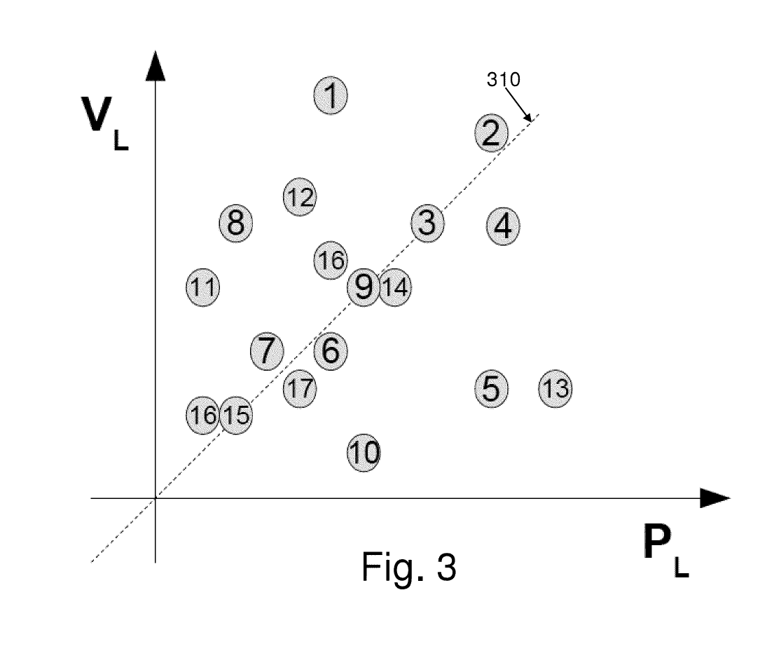

The plotter 220 may plot the physical load versus the aggregate virtual load for the various physical machines 250. An exemplary such plot is a scatter plot such as that shown in FIG. 3, in which each point represents a physical machine 250 for which load data was received by the load converter 210. In FIG. 3, a diagonal central line 310 extends through the plot. This line may represent where physical load is equal to aggregate virtual load. Thus, a point may be positioned directly on this line 310 for a physical machine having an aggregate virtual load equal to its physical load. Well-behaving physical machines 250 may be represented by points positioned near the central line 310, while misbehaving physical machines 310 may be represented by points positioned farther away from the diagonal line.

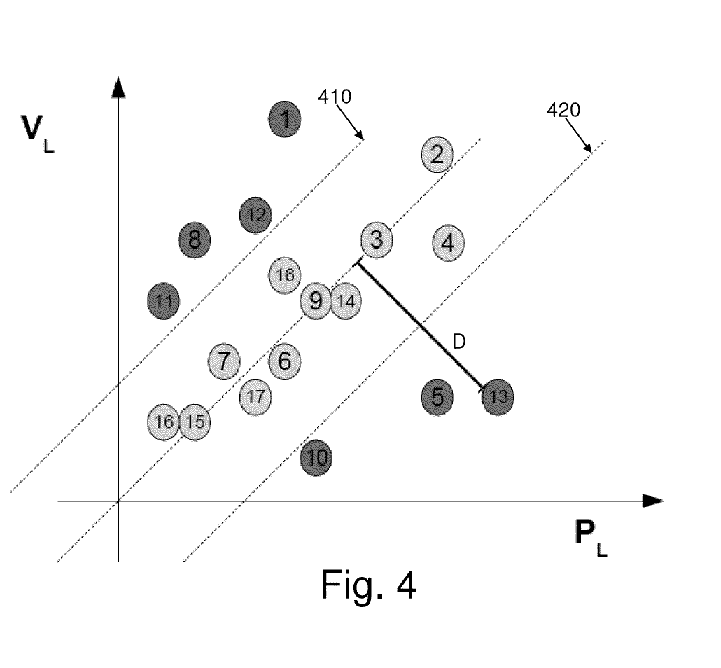

FIG. 4 shows a an exemplary plot of the physical load versus aggregate virtual load of each of the physical machines 250, further indicating a range of values representing acceptably behaving physical machines 250. As shown, two additional diagonal lines 410 and 420 are added to this plot, as compared to the plot in FIG. 3. A first line 410 indicates an upper bound on the aggregate virtual load given the physical load. A second line 420 indicates a lower bound on the aggregate virtual load given the physical load. Physical machines 250 represented by points lying above the first line 410 or below the second line 420 may be classified as misbehaving, or behaving unacceptably. In a healthy environment, only a small percentage of the total number of physical machines 250 will be represented by points lying outside the well-behaving range. Using this range, as opposed to requiring that the points fall directly on the central line 310 may allow some leeway in system behavior.

The first and second lines 410 and 420 may be used as alert thresholds, and the detection system 200 may alert a user, such as an administrator, of physical machines 250 that fall outside the range provided by the thresholds. In some embodiments, identifying a physical machine 250 that falls outside the desired, well-behaving range may be performed by computing a distance D between the applicable point representing the physical machine 250 and the central line 310, where such distance D is taken in a perpendicular direction from the central line 310. If that distance D exceeds a threshold distance, i.e., the distance between the central line 310 and the applicable first or second line 410 or 420, then the physical machine 250 may deemed to fall outside the acceptable range and may thus be deemed to be misbehaving.

In some embodiments, the user may select misbehaving physical machines 250 from a provided graphical representation, such as those presented in FIGS. 3-4. For example, and not by way of limitation, the user may select a point to select the physical machine 250 represented by that point. When the physical machine 250 is selected, the user can then troubleshoot the machine 250, instruct the detection system 200 to issue an alert related to that physical machine 250, or take some other action related to the physical machine 250.

It will be understood that the plotting discussed herein need not require actual rendering of a graph for display. Rather, for example, the plotter 220 may instead calculate the range of aggregate virtual load values acceptable for the physical load of each physical machine 250. In some embodiments, such range may be representable by the range between two straight lines 410 and 420 running approximately parallel to a line 310 representing equal physical and aggregate virtual loads, but no graphical representation of such range need be performed. In the absence of a graphical representation, the ticketer 230 may instead report to the user which physical machines 250 lie outside of the well-behaving range without graphical illustration by the plotter 220.

When a misbehaving physical machine 250 is identified, the ticketer 230 may provide an alert, notifying the user of the misbehavior. The alert may be provided in various forms. For example, and not by way of limitation, the alert may be provided as a ticket, an email, an audible alarm, or other form of notification. A human or automated user may receive the alert and address the misbehaving physical machine 250 as needed.

In an exemplary embodiment of the detection system 200, the agents 270 may run continuously or periodically on the physical machines, thus continuously or periodically updating the load data provided to the load converter 210. The load converter 210 may recalculate the total virtual loads and physical loads of the physical machines 250 after new load data is received. In turn, the plotter 220 may also update its plot of the physical systems 250, or other representation thereof. Accordingly, the detection system 200 may be enabled to identify that a physical machine 250 is currently misbehaving even though it was previously well-behaved. Thus, over time, the detection system 200 may assist in maintaining a healthy computing environment for the physical machines 250.

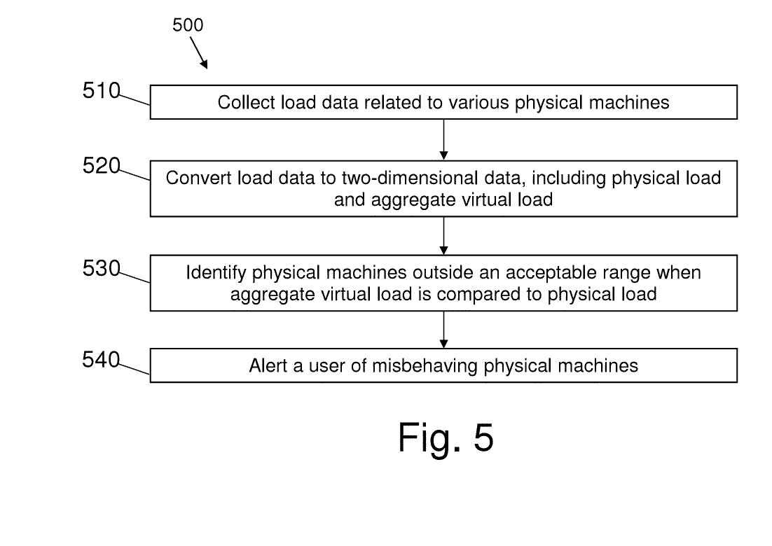

FIG. 5 is a flow diagram of a method 500 for detecting a misbehaving physical machine 250 in an environment of physical machines 250. As shown, at block 510, load data is collected related to various physical machines 250 and their associated virtual machines 260. At block 520, a conversion formula may be applied to the load data of each physical machine 250, converting each physical machine's load data to a data point having two or more dimensions. In an exemplary embodiment, the conversion formula results in an aggregate virtual load and a physical load for each physical machine 250. At block 530, one or more physical machines 250 outside an acceptable range may be identified. Such identification may be made by plotting the aggregate virtual load versus the physical load for each physical machine 250, and identifying physical machines 250 that fall outside a graphical range. At block 540, an alert may be provided for each misbehaving machine 250.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a plurality of load data related to a plurality of physical machines in a computing environment;
converting the plurality of load data to a plurality of data points, each data point representing a corresponding physical machine from among the physical machines;
generating, by a computer processor, a graph of the plurality of data points representing the plurality of physical machines; and
outputting a misbehavior alert for each of the physical machines that falls outside a predetermined safe range in the graph.

2. The method of claim 1, wherein a first set of load data, from among the plurality of load data, corresponds to a first physical machine and indicates a virtual load on each virtual machine running on the first physical machine.

3. The method of claim 1, wherein a first data point corresponding to the first physical machine comprises at least two dimensions of data, comprising a first dimension representing physical load and a second dimension representing aggregate virtual load.

4. The method of claim 3, wherein the first physical machine runs a set of virtual machines, and wherein the aggregate virtual load is calculated as the sum over the set of virtual machines of, for each virtual machine, a virtual load multiplied by a quantity of virtual processors assigned to the virtual machine.

5. The method of claim 1, wherein the graph represents an aggregate virtual load versus a physical load for the plurality of physical machines.

6. The method of claim 5, further comprising identifying a first physical machine, from among the plurality of physical machines, as misbehaving based on a position of the data point representing the first physical machine in the graph.

7. The method of claim 6, further comprising providing an upper threshold and a lower threshold as the safe zone in the graph, wherein the first physical machine is identified as misbehaving when represented by a data point positioned above the upper threshold or below the lower threshold.

8. A system comprising:
a load converter configured to receive a plurality of load data related to a plurality of physical machines in a computing environment, and to convert the plurality of load data to a plurality of data points, each data point representing a corresponding physical machine from among the physical machines;
a plotter configured to generate, by a computer processor, a graph of the plurality of data points representing the plurality of physical machines; and
a ticketer configured to output a misbehavior alert for each of the physical machines that falls outside a predetermined safe range in the graph.

9. The system of claim 8, wherein a first set of load data, from among the plurality of load data, corresponds to a first physical machine and indicates a virtual load on each virtual machine running on the first physical machine.

10. The system of claim 8, wherein a first data point corresponding to the first physical machine comprises at least two dimensions of data, comprising a first dimension representing physical load and a second dimension representing aggregate virtual load.

11. The system of claim 10, wherein the first physical machine runs a set of virtual machines, and wherein the aggregate virtual load is calculated as the sum over the set of virtual machines of, for each virtual machine, a virtual load multiplied by a quantity of virtual processors assigned to the virtual machine.

12. The system of claim 8, wherein the graph represents an aggregate virtual load versus a physical load for the plurality of physical machines.

13. The system of claim 12, the ticketer being further configured to identify a first physical machine, from among the plurality of physical machines, as misbehaving based on a position of the data point representing the first physical machine in the graph.

14. The system of claim 13, the plotter being further configured to provide an upper threshold and a lower threshold as the safe zone in the graph, wherein the first physical machine is identified as misbehaving when represented by a data point positioned above the upper threshold or below the lower threshold.

15. A computer program product comprising a computer readable storage medium having computer readable program code embodied thereon, the computer readable program code executable by a processor to perform a method comprising:
receiving a plurality of load data related to a plurality of physical machines in a computing environment;
converting the plurality of load data to a plurality of data points, each data point representing a corresponding physical machine from among the physical machines;
generating a graph of the plurality of data points representing the plurality of physical machines; and
outputting a misbehavior alert for each of the physical machines that falls outside a predetermined safe range in the graph.

16. The computer program product of claim 15, wherein a first data point corresponding to the first physical machine comprises at least two dimensions of data, comprising a first dimension representing physical load and a second dimension representing aggregate virtual load.

17. The computer program product of claim 16, wherein the first physical machine runs a set of virtual machines, and wherein the aggregate virtual load is calculated as the sum over the set of virtual machines of, for each virtual machine, a virtual load multiplied by a quantity of virtual processors assigned to the virtual machine.

18. The computer program product of claim 15, wherein the graph represents an aggregate virtual load versus a physical load for the plurality of physical machines.

19. The computer program product of claim 18, the method further comprising identifying a first physical machine, from among the plurality of physical machines, as misbehaving based on a position of the data point representing the first physical machine in the graph.

20. The computer program product of claim 19, the method further comprising providing an upper threshold and a lower threshold as the safe zone in the graph, wherein the first physical machine is identified as misbehaving when represented by a data point positioned above the upper threshold or below the lower threshold.
